(19) United States
(12) Patent Application Publication
(10) Pub. No.: US 2024/0125959 A1
(43) Pub. Date: Apr. 18, 2024

(54) METHOD FOR PREDICTING THE SIZE RANGE OF LOST CIRCULATION CHANNEL BASED ON DEEP LEARNING (DL)

(71) Applicant: Southwest Petroleum University, Chengdu (CN)

(72) Inventors: Gui WANG, Chengdu (CN); Rongcang FAN, Chengdu (CN); Zhengguo ZHAO, Chengdu (CN); Xiantao XIE, Chengdu (CN); Yanjun REN, Chengdu (CN); Fang LI, Chengdu (CN)

(73) Assignee: Southwest Petroleum University, Chengdu (CN)

(21) Appl. No.: 18/128,245

(22) Filed: Mar. 30, 2023

(30) Foreign Application Priority Data
Oct. 8, 2022 (CN) 202211219444.5

(51) Int. Cl. G01V 1/30; G01V 1/28

(52) U.S. Cl. CPC G01V 1/306; G01V 1/282; G01V 1/307

(57) ABSTRACT

A method for predicting a size range of a lost circulation channel based on deep learning (DL) is provided. The method includes the following steps: S1: acquiring data of the lost circulation channel, and establishing a prediction dataset of the size range of the lost circulation channel; S2: preprocessing the prediction dataset of the size range of the lost circulation channel, and determining the size range of the lost circulation channel; S3: establishing a prediction model for the size range of the lost circulation channel; and S4: optimizing the prediction model for the size range of the lost circulation channel, and predicting the size range of the lost circulation channel. The method overcomes the shortcomings of conventional methods, for example, the prediction value of the size of the downhole lost circulation channel is single, inaccurate and not real-time.

### CROSS REFERENCE TO THE RELATED APPLICATIONS

This application is based upon and claims priority to Chinese Patent Application No. 202211219444.5, filed on Oct. 8, 2022, the entire contents of which are incorporated herein by reference.

### TECHNICAL FIELD

The present disclosure belongs to the technical field of lost circulation control in oil drilling engineering and specifically relates to a method for predicting a size range of a lost circulation channel based on deep learning (DL).

### BACKGROUND

The lost circulation of drilling fluid will increase non-production time and operating costs and lead to safety hazards such as wellbore instability, jamming of a drilling tool, and blowout. Therefore, it is of great importance to establish a prediction model for the size range of the lost circulation channel and predict the size range of the lost circulation channel in different formations for rapid decision-making of the lost circulation treatment plan, drilling engineering safety, and cost control.

The conventional prediction method for the size of the lost circulation channel is mainly to identify the hole and fracture system through seismic or logging data. However, the analytical accuracy of seismic and logging data is limited, and only large fractures and formations rather than small fractures can be properly identified. The dynamic breathing effect of fractures and the difference between imaging logging conditions and drilling conditions will lead to a calculation deviation of the size of the downhole lost circulation channel. As a machine learning (ML) method, DL has unique advantages in dealing with the uncertainty of complex drilling problems, identifying hidden patterns, and revealing useful information.

### SUMMARY

In order to solve the above problems, the present disclosure proposes a method for predicting a size range of a lost circulation channel based on DL.

The present disclosure adopts the following technical solution: the method for predicting a size range of a lost circulation channel based on DL includes the following steps:
S1: acquiring data of the lost circulation channel, and establishing a prediction dataset of the size range of the lost circulation channel;
S2: preprocessing the prediction dataset of the size range of the lost circulation channel, and determining the size range of the lost circulation channel;
S3: establishing a prediction model for the size range of the lost circulation channel by taking the pre-processed prediction dataset of the size range of the lost circulation channel as an input and the size range of the lost circulation channel as an output; and
S4: optimizing the prediction model for the size range of the lost circulation channel, and predicting the size range of the lost circulation channel through the optimized prediction model for the size range of the lost circulation channel.

Further, in step S1, the prediction dataset of the size range of the lost circulation channel includes a drilling parameter, a drilling fluid parameter, a geomechanical model parameter, and a lost circulation parameter; and
the drilling parameter includes well depth, borehole size, penetration rate, rotary speed, torque, weight on bit, displacement, pump pressure, pump stroke, and well trajectory; the drilling fluid parameter includes density, Marsh funnel viscosity, plastic viscosity, yield point, initial gel strength, final gel strength, filtration, and solid content; the geomechanical model parameter includes lithology type, rock mechanical parameter, pore pressure, formation fracture pressure, vertical stress, minimum horizontal stress, and maximum horizontal stress; the lost circulation parameter includes lost circulation speed, lost circulation amount, lost circulation time, lost circulation degree, lost circulation condition, and bit position; and the rock mechanical parameter includes elastic parameter, unconfined compressive strength, tensile strength, shear strength, internal friction angle, and cohesion strength.

Further, in step S2, the preprocessing the prediction dataset of the size range of the lost circulation channel specifically includes: performing data cleaning, feature coding, and data normalization in sequence on the prediction dataset of the size range of the lost circulation channel to obtain a feature vector, thus completing data preprocessing.

Further, in step S2, the data normalization is calculated as follows:

$${x}_{i} = \frac{{x}_{r a w} - {x}_{min}}{{x}_{max} - {x}_{min}}$$

where, xᵢ∈{x₁, x₂ . . . , xₙ}; n denotes a total number of features in the prediction dataset of the size range of the lost circulation channel; xᵢ denotes normalized feature data of the size range of the lost circulation channel; x_{raw} denotes raw feature data; xₘᵢₙ denotes minimum feature data; and xₘₐₓ denotes maximum feature data;
in step S2, the size range of the lost circulation channel is calculated as follows:

$${D}_{50} = ( 0.2 - 0.5 ) {W}_{f}$$

$${D}_{90} = ( 0.5 - 0.7 ) {W}_{f}$$

$${y}_{1} = \frac{1}{2} ( 2 {D}_{50} + \frac{10}{7} {D}_{90} )$$

$${y}_{2} = \frac{1}{2} ( 5 {D}_{50} + 2 {D}_{90} )$$

where, (y₁, y₂) denotes a vector of the size range of the lost circulation channel; y₁ i denotes a minimum value of the size range of the lost circulation channel; y₂ denotes a maximum value of the size range of the lost circulation channel; D₅₀ denotes a particle size corresponding to a cumulative particle size distribution 50% of a lost circulation control formula; D₉₀ denotes a particle size corresponding to a cumulative particle size distribution 90% of the lost circulation control formula; and W_{f} denotes a size of the lost circulation channel.

Further, in step S3, the establishing a prediction model for the size range of the lost circulation channel specifically includes: designing, by taking the pre-processed prediction dataset of the size range of the lost circulation channel as the input, a regularized loss function L(ŷ⁽ⁱ⁾, y⁽ⁱ⁾) and a performance evaluation index mean square error (MSE) of the prediction model for the size range of the lost circulation channel, and setting parameters of the prediction model for the size range of the lost circulation channel, namely a number L of hidden layers, a number n^{(L)} of neurons in each of the hidden layers, and an activation function g (x) corresponding to each of the hidden layers; and iterating, according to the regularized loss function L(ŷ⁽ⁱ⁾, y⁽ⁱ⁾) of the prediction model for the size range of the lost circulation channel, a model with the number L of the hidden layers, the number n^{(L)} of the neurons in each of the hidden layers, and the activation function g(x) corresponding to each of the hidden layers, until an optimal performance evaluation index MSE, thus completing the establishment of the prediction model for the size range of the lost circulation channel, where, ŷ⁽ⁱ⁾ denotes a prediction vector of the prediction model for the size range of the lost circulation channel; and y⁽ⁱ⁾ denotes a true vector of the size range of the lost circulation channel.

Further, an output layer of the prediction model for the size range of the lost circulation channel takes a rectified linear unit (ReLU) function as an activation function;
the regularized loss function L(ŷ⁽ⁱ⁾, y⁽ⁱ⁾) of the prediction model for the size range of the lost circulation channel is expressed as follows:

$$L ( {\hat{y}}^{( i )} , {y}^{( i )} ) = \frac{1}{2 m} {\sum }_{i = 1}^{m} [ {( ( {\hat{y}}^{( i )} ) - {y}^{( i )} )}^{2} + λ {‖ W ‖}^{2} ) ]$$

where, ŷ⁽ⁱ⁾ denotes the prediction vector of the prediction model for the size range of

the lost circulation channel; y⁽ⁱ⁾ denotes the true vector of the size range of the lost circulation channel; m denotes a number of samples in the dataset; λ denotes a regularization parameter of the prediction model for the size range of the lost circulation channel; and W denotes a weight matrix of the prediction model for the size range of the lost circulation channel; and
the performance evaluation index MSE of the prediction model for the size range of the lost circulation channel is calculated as follows:

$$MSE = \frac{1}{m} {\sum }_{i = 1}^{m} {( {y}^{( i )} - {\hat{y}}^{( i )} )}^{2} .$$

Further, step S4 includes the following sub-steps:
S41: establishing a training sample matrix of the prediction model for the size range of the lost circulation channel;
S42: dividing the training sample matrix into subsets, and setting a number of iterations;
S43: calculating an input vector and an output vector of each layer of the prediction model for the size range of the lost circulation channel in each of the subsets, until a prediction vector of the prediction model for the size range of the lost circulation channel is obtained;
S44: calculating a loss cost function of the prediction model for the size range of the lost circulation channel in each of the subsets according to the prediction vector of the prediction model for the size range of the lost circulation channel;
S45: calculating a weighted differential and a biased differential of each layer of the prediction model for the size range of the lost circulation channel through a back-propagation (BP) algorithm;
S46: calculating an exponentially weighted average of a Momentum weighted differential, an exponentially weighted average of a Momentum biased differential, a weighted average of a square of an RMSprop weighted differential, and a weighted average of a square of an RMSprop biased differential; and calculating an exponentially weighted average of a corrected Momentum weighted differential, an exponentially weighted average of a corrected Momentum biased differential, a weighted average of a square of a corrected RMSprop weighted differential, and a weighted average of a square of a corrected RMSprop biased differential, according to the exponentially weighted average of the Momentum weighted differential, the exponentially weighted average of the Momentum biased differential, the weighted average of the square of the RMSprop weighted differential, and the weighted average of the square of the RMSprop biased differential;
S47: updating a weight and a bias of the prediction model for the size range of the lost circulation channel; and
S48: repeating steps S43 to S47 until the set number of iterations to complete the optimization of the prediction model for the size range of the lost circulation channel, and predicting the size range of the lost circulation channel through the optimized prediction model for the size range of the lost circulation channel.

Further, in step S41, the training sample matrix includes an input matrix X defined by a feature vector and an output matrix Y defined a vector of the size range of the lost circulation channel, where X=[x⁽¹⁾|x⁽²⁾|x⁽³⁾ . . . x^{(m)}], Y=[y⁽¹⁾|y⁽²⁾]; x⁽¹⁾ . . . x^{(m)} denotes an input parameter vector of the prediction model for the size range of the lost circulation channel, and each term of the input parameter vector is defined by the feature vector (x₁, x₂ . . . , xₙ); y⁽¹⁾ and y⁽²⁾ denote an output vector of the prediction model for the size range of the lost circulation channel, and each term of the output vector is defined by a vector (y₁, y₂) of the size range of the lost circulation channel; m denotes a number of training samples of the prediction model for the size range of the lost circulation channel; n denotes a total number of features in the prediction dataset of the size range of the lost circulation channel; y₁ denotes a minimum value of the size range of the lost circulation channel; and y₂ denotes a maximum value of the size range of the lost circulation channel;
in step S43, the input vector Z^{[i]} and the output vector A^{[i]} of each layer of the prediction model for the size range of the lost circulation channel are calculated as follows:

Z^{[i]}=W^{[i]}X^{{i}}+b^{[i]}

A^{[i]}=g^{[i]}(Z^{[i]})

where, W^{[i]} denotes a weight matrix of each layer of the prediction model for the size range of the lost circulation channel; b^{[i]} denotes a bias of each layer of the prediction model for the size range of the lost circulation channel; and g^{[i]} denotes an activation function of each layer of the prediction model for the size range of the lost circulation channel;
in step S43, the prediction vector ŷ⁽ⁱ⁾ of the prediction model for the size range of the lost circulation channel is calculated as follows:

y⁽ⁱ⁾=g^{[L]}(Z^{[L]})

where, g^{[L]} denotes an activation function of a last layer of the prediction model for the size range of the lost circulation channel; and Z^{[L]} denotes an input vector of the last layer of the prediction model for the size range of the lost circulation channel;
in step S44, the loss cost function J of the prediction model for the size range of the lost circulation channel is calculated as follows:

$$J = \frac{1}{256} {\sum }_{i = 1}^{256} L ( {\hat{y}}^{( i )} , {y}^{( i )} ) + \frac{λ}{2 * 256} {\sum }_{256} {‖ {W}^{[ 256 ]} ‖}_{F}^{2}$$

where, ŷ⁽ⁱ⁾ denotes the prediction vector of the prediction model for the size range of the lost circulation channel; y⁽ⁱ⁾ denotes a true vector of the size range of the lost circulation channel; L(ŷ⁽ⁱ⁾, y⁽ⁱ⁾) denotes a regularized loss function of the prediction model for the size range of the lost circulation channel; λ denotes a regularization parameter of the prediction model for the size range of the lost circulation channel; and ||W^{[256]}||_{F}² denotes a square of Frobenius norm of the weight matrix of the prediction model for the size range of the lost circulation channel;
in step S46, the exponentially weighted average v_{dw}* of the Momentum weighted differential, the exponentially weighted average v_{db}* of the Momentum biased differential, the weighted average S_{dW}* of the square of the RMSprop weighted differential, and the weighted average S_{db}* of the square of the RMSprop biased differential are calculated as follows:

v_{dW}*=β₁v_{dW}+(1−β₁)dW

v_{db}*=β₁v_{db}+(1−β₁)db

S_{dW}*=β₂S_{dW}+(1−β₂)(dW)²

S_{db}*=β₂S_{db}+(1−β₂)(db)²

where, V_{dw} denotes an exponentially weighted average of an original Momentum weighted differential; v_{db} denotes an exponentially weighted average of an original Momentum biased differential; S_{dW} denotes a weighted average of a square of an original RMSprop weighted differential; S_{db} denotes a weighted average of a square of an original RMSprop biased differential; β₁ denotes a first hyper-parameter of the prediction model for the size range of the lost circulation channel; and β₂ denotes a second hyper-parameter of the prediction model for the size range of the lost circulation channel;
in step S46, the exponentially weighted average v_{dW}^{corrected} of the corrected Momentum weighted differential, the exponentially weighted average V_{db}^{corrected} of the corrected Momentum biased differential, the weighted average S_{dW}^{corrected} of the square of the corrected RMSprop weighted differential, and the weighted average S_{db}^{corrected} of the square of the corrected RMSprop biased differential are calculated as follows:

$${v}_{dW}^{corrected} = \frac{{v}_{dW}}{1 - {β}_{1}^{q}}$$

$${v}_{db}^{corrected} = \frac{{v}_{db}}{1 - {β}_{1}^{q}}$$

$${S}_{dW}^{corrected} = \frac{{S}_{dW}}{1 - {β}_{2}^{q}}$$

$${S}_{db}^{corrected} = \frac{{S}_{db}}{1 - {β}_{2}^{q}}$$

where, q denotes the current iteration number;
in step S47, an updated weight and bias of the prediction model for the size range of the lost circulation channel are calculated as follows:

$${W}^{*} = W - \frac{α {v}_{dW}^{corrected}}{\sqrt{{S}_{dW}^{corrected}} + ε}$$

$${b}^{*} = b - \frac{α {v}_{db}^{corrected}}{\sqrt{{S}_{db}^{corrected}} + ε}$$

where, W* denotes the updated weight of the prediction model for the size range of the lost circulation channel; b* denotes the updated bias of the prediction model for the size range of the lost circulation channel; W denotes the weight of the prediction model for the size range of the lost circulation channel; b denotes the bias of the prediction model for the size range of the lost circulation channel; a denotes a learning rate of the prediction model for the size range of the lost circulation channel; and ε denotes an infinitesimal.

The present disclosure has the following advantages. The present disclosure overcomes the shortcomings of conventional methods, for example, the prediction value of the size of the downhole lost circulation channel is single, inaccurate and not real-time. The present disclosure makes real-time prediction of the size range of the downhole lost circulation channel through a DL model, avoids complexity and uncertainty of conventional manual feature selection, and is more in line with the site engineering construction specifications. The present disclosure has positive practical significance for the rapid decision-making of the lost circulation treatment plan, and drilling engineering safety and cost control.

### BRIEF DESCRIPTION OF THE DRAWINGS

FIG. 1 is a flowchart of a method for predicting a size range of a lost circulation channel;

FIG. 2 is a schematic diagram of a ReLU function; and

FIG. 3 is a schematic diagram of a prediction model for the size range of the lost circulation channel.

### DETAILED DESCRIPTION OF THE EMBODIMENTS

The embodiments of the present disclosure are described in further detail with reference to the drawings.

BP algorithm is a learning algorithm suitable for multi-layer neural networks, which is based on a gradient descent method. The input-output relationship of the BP network is essentially a mapping relationship. The function of the BP neural network with n inputs and m outputs is a continuous mapping from an n-dimensional Euclidean space to a finite field in an m-dimensional Euclidean space, which is highly nonlinear.

Momentum algorithm is a momentum gradient descent algorithm.

The RMSprop algorithm is a root mean square propagation algorithm.

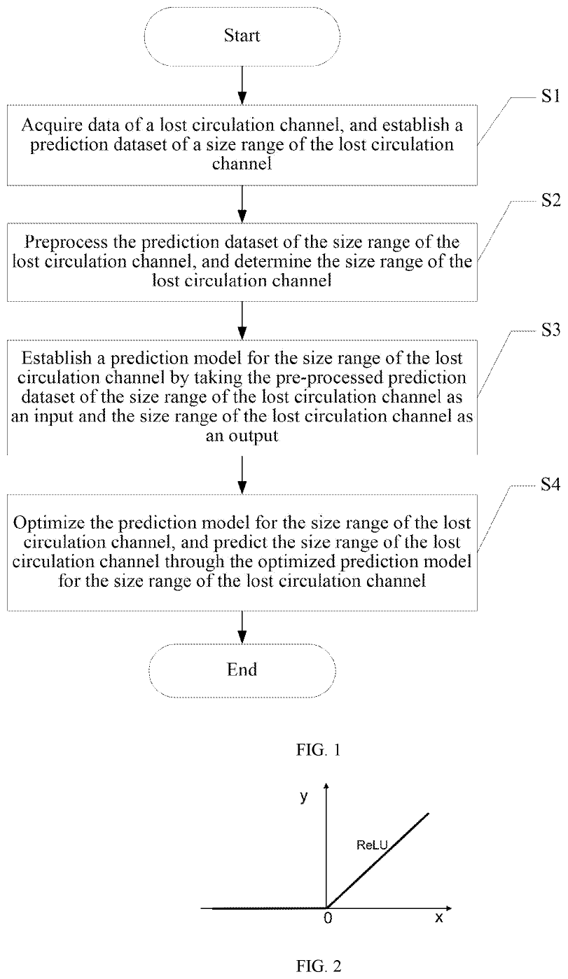

As shown in FIG. 1, the present disclosure provides a method for predicting a size range of a lost circulation channel based on DL, including the following steps.
S1. Data of the lost circulation channel is acquired, and a prediction dataset of the size range of the lost circulation channel is established.
S2. The prediction dataset of the size range of the lost circulation channel is preprocessed, and the size range of the lost circulation channel is determined.
S3. A prediction model for the size range of the lost circulation channel is established by taking the pre-processed prediction dataset of the size range of the lost circulation channel as an input and the size range of the lost circulation channel as an output; and
S4: the prediction model for the size range of the lost circulation channel is optimized, and the size range of the lost circulation channel is predicted through the optimized prediction model for the size range of the lost circulation channel.

In the embodiment of the present disclosure, in step S1, the prediction dataset of the size range of the lost circulation channel includes a drilling parameter, a drilling fluid parameter, a geomechanical model parameter, and a lost circulation parameter.

The drilling parameter includes well depth, borehole size, penetration rate, rotary speed, torque, weight on bit, displacement, pump pressure, pump stroke, and well trajectory; the drilling fluid parameter includes density, Marsh funnel viscosity, plastic viscosity, yield point, initial gel strength, final gel strength, filtration, and solid content; the geomechanical model parameter includes lithology type, rock mechanical parameter, pore pressure, formation fracture pressure, vertical stress, minimum horizontal stress, and maximum horizontal stress; the lost circulation parameter includes lost circulation speed, lost circulation amount, lost circulation time, lost circulation degree, lost circulation condition, and bit position; and the rock mechanical parameter includes elastic parameter, unconfined compressive strength, tensile strength, shear strength, internal friction angle, and cohesion strength.

In the embodiment of the present disclosure, in step S2, the prediction dataset of the size range of the lost circulation channel is specifically preprocessed by performing data cleaning, feature coding, and data normalization in sequence on the prediction dataset of the size range of the lost circulation channel to obtain a feature vector, thus completing data preprocessing.

The data cleaning is specifically implemented as follows. An invalid sample in the prediction dataset of the size range of the lost circulation channel is removed, non-empty missing data in the prediction dataset of the size range of the lost circulation channel is filled in, and numerical processing is performed on abnormal data in the prediction dataset of the size range of the lost circulation channel.

The DL method cannot be trained with text or symbol data. In this case, text or non-numeric information must be converted into numeric data. The present disclosure converts non-numerical data into a digital form by means of one-hot encoding, such as a rock type feature, and the code is shown in Table 1.

TABLE 1

| Lithology | Code |
|---|---|
| Dolomite | 1000000000 |
| Dolomitic limestone | 0100000000 |
| Anhydrite | 0010000000 |
| Gypsum-containing | 0001000000 |
| calcareous mudstone | |
| Limestone | 0000100000 |
| Cretaceous limestone | 0000010000 |
| Marly limestone | 0000001000 |
| Argillaceous limestone | 0000000100 |
| Shaly limestone | 0000000010 |
| Sandstone | 0000000001 |

In the embodiment of the present disclosure, a Min-max normalization method is used to normalize the dataset data as follows:

$${x}_{i} = \frac{{x}_{raw} - {x}_{min}}{{x}_{max} - {x}_{min}}$$

where, xᵢ∈{x₁, x₂ . . . , xₙ}; n denotes a total number of features in the prediction dataset of the size range of the lost circulation channel; xᵢ denotes normalized feature data of the size range of the lost circulation channel; x_{raw} denotes raw feature data; xₘᵢₙ denotes minimum feature data; and xₘₐₓ denotes maximum feature data;
in step S2, the size range of the lost circulation channel is calculated as follows:

$${D}_{50} = ( 0.2 - 0.5 ) {W}_{f}$$

$${D}_{90} = ( 0.5 - 0.7 ) {W}_{f}$$

$${y}_{1} = \frac{1}{2} ( 2 {D}_{50} + \frac{10}{7} {D}_{90} )$$

$${y}_{2} = \frac{1}{2} ( 5 {D}_{50} + 2 {D}_{90} )$$

where, (y₁, y₂) denotes a vector of the size range of the lost circulation channel; y₁ denotes a minimum value of the size range of the lost circulation channel; y₂ denotes a maximum value of the size range of the lost circulation channel; D₅₀ denotes a particle size corresponding to a cumulative particle size distribution 50% of a lost circulation control formula; D₉₀ denotes a particle size corresponding to a cumulative particle size distribution 90% of the lost circulation control formula; and W_{f} denotes a size of the lost circulation channel.

In the embodiment of the present disclosure, in step S3, a typical DL model includes an input layer, multiple hidden layers, and an output layer. The present disclosure takes the pre-processed feature vector of the dataset of the size range of the lost circulation channel as the input and the vector of the size range of the lost circulation channel as the output. The present disclosure randomly allocates 80% of the data as a training set, 10% of the data as a verification set, and 10% of the data as a test set. The training set is configured to develop the DL prediction model for the size range of the lost circulation channel, and the output vector in the training set is configured to help the model adjust the weight of each input. The validation set is configured to improve the generalization ability of the model and stop training when the generalization stops improving. The test set is configured to test the accuracy of the model after the training and validation steps.

The prediction model for the size range of the lost circulation channel is specifically established as follows. By taking the pre-processed prediction dataset of the size range of the lost circulation channel as the input, a regularized loss function L(ŷ⁽ⁱ⁾,y⁽ⁱ⁾) performance evaluation index MSE of the prediction model for the size range of the lost circulation channel are designed, and parameters of the prediction model for the size range of the lost circulation channel are set, namely a number L of hidden layers, a number n^{(L)} of neurons in each of the hidden layers, and an activation function g(x) corresponding to each of the hidden layers. According to the regularized loss function L(ŷ⁽ⁱ⁾,y⁽ⁱ⁾) of the prediction model for the size range of the lost circulation channel, a model with the number L of the hidden layers, the number n^{(L)} of the neurons in each of the hidden layers, and the activation function g (x) corresponding to each of the hidden layers is iterated, until an optimal performance evaluation index MSE, thus completing the establishment of the prediction model for the size range of the lost circulation channel. ŷ⁽ⁱ⁾ denotes a prediction vector of the prediction model for the size range of the lost circulation channel; and y⁽ⁱ⁾ denotes a true vector of the size range of the lost circulation channel.

In the embodiment of the present disclosure, as shown in FIG. 2, in order to quickly converge the model and prevent the gradient from disappearing, the output layer of the prediction model for the size range of the lost circulation channel takes a ReLU function as the activation function.

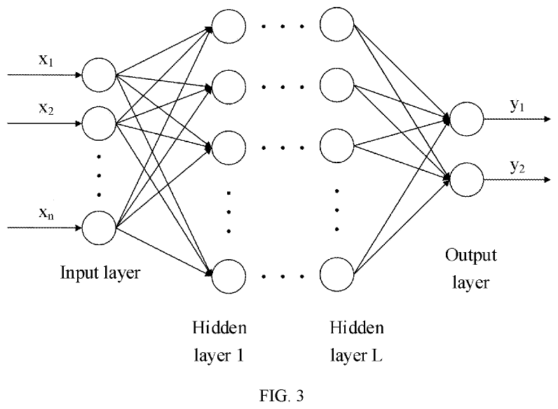

In the present disclosure, the output layer includes two neurons, which denote a minimum value and a maximum value of the output size of the lost circulation channel. The best DL model is derived by comparing the performance evaluation indicators of the model. The final prediction model for the size range of the lost circulation channel is shown in FIG. 3.

In the embodiment of the present disclosure, an output layer of the prediction model for the size range of the lost circulation channel takes a rectified linear unit (ReLU) function as an activation function;

In order to calculate the error generated by the prediction model for the size range of the lost circulation channel, the regularized loss function L(ŷ⁽ⁱ⁾,y⁽ⁱ⁾) of the prediction model for the size range of the lost circulation channel is expressed as follows:

$$L ( {\hat{y}}^{( i )} , {y}^{( i )} ) = \frac{1}{2 m} {\sum }_{i = 1}^{m} [ {( ( {\hat{y}}^{( i )} ) - {y}^{( i )} )}^{2} + λ {‖ W ‖}^{2} ) ]$$

where, ŷ⁽ⁱ⁾ denotes the prediction vector of the prediction model for the size range of

the lost circulation channel; y⁽ⁱ⁾ denotes the true vector of the size range of the lost circulation channel; m denotes a number of samples in the dataset; λ denotes a regularization parameter of the prediction model for the size range of the lost circulation channel; and W denotes a weight matrix of the prediction model for the size range of the lost circulation channel; and

In order to evaluate the quality of the prediction model for the size range of the lost circulation channel, the performance evaluation index MSE of the prediction model for the size range of the lost circulation channel is calculated as follows:

$$MSE = \frac{1}{m} {\sum }_{i = 1}^{m} {( {y}^{( i )} - {\hat{y}}^{( i )} )}^{2} .$$

In the embodiment of the present disclosure, the mini-batch gradient descent plus Adam optimization algorithm is used to optimize the model of the established size range of the lost circulation channel. The mini-batch algorithm divides the training set into multiple subsets to accelerate the iteration of the model. The Adam optimization algorithm combines the advantages of The Momentum algorithm and The RMSprop algorithm, and is suitable for the optimization of different DL structures. Step S4 includes the following sub-steps:
S41. A training sample matrix of the prediction model for the size range of the lost circulation channel is established.
S42. The training sample matrix is divided into subsets, and a number of iterations is set. 256 samples of the prediction data of the size range of the lost circulation channel are taken as a subset for mini-batch division, and t subsets in total are divided, which are denoted as X^{{t}} and Y^{{y}}.
S43. An input vector and an output vector of each layer of the prediction model for the size range of the lost circulation channel in each of the subsets are calculated, until a prediction vector of the prediction model for the size range of the lost circulation channel is obtained.
S44. A loss cost function of the prediction model for the size range of the lost circulation channel in each of the subsets is calculated according to the prediction vector of the prediction model for the size range of the lost circulation channel.
S45. A weighted differential and a biased differential of each layer of the prediction model for the size range of the lost circulation channel are calculated through a BP algorithm.
S46. An exponentially weighted average of a Momentum weighted differential, an exponentially weighted average of a Momentum biased differential, a weighted average of a square of an RMSprop weighted differential, and a weighted average of a square of an RMSprop biased differential are calculated, and an exponentially weighted average of a corrected Momentum weighted differential, an exponentially weighted average of a corrected Momentum biased differential, a weighted average of a square of a corrected RMSprop weighted differential, and a weighted average of a square of a corrected RMSprop biased differential are calculated, according to the exponentially weighted average of the Momentum weighted differential, the exponentially weighted average of the Momentum biased differential, the weighted average of the square of the RMSprop weighted differential, and the weighted average of the square of the RMSprop biased differential.
S47. A weight and a bias of the prediction model for the size range of the lost circulation channel are updated.
S48. Steps S43 to S47 are repeated until the set number of iterations to complete the optimization of the prediction model for the size range of the lost circulation channel, and the size range of the lost circulation channel is predicted through the optimized prediction model for the size range of the lost circulation channel.

After the optimization is completed and the best model is selected and deployed, the size range of the downhole lost circulation channel is predicted in real time according to the field data, thus providing decision support for construction personnel to select the best lost circulation treatment plan.

In the embodiment of the present disclosure, in step S41, the training sample matrix includes an input matrix X defined by a feature vector and an output matrix Y defined a vector of the size range of the lost circulation channel, where X=[x⁽¹⁾|x⁽²⁾|x⁽³⁾ . . . x^{(m)}], Y=[y⁽¹⁾|y⁽²⁾]; x⁽¹⁾ . . . x^{(m)} denotes an input parameter vector of the prediction model for the size range of the lost circulation channel, and each term of the input parameter vector is defined by the feature vector (x₁, x₂ . . . , xₙ); y⁽¹⁾ and y⁽²⁾ denote an output vector of the prediction model for the size range of the lost circulation channel, and each term of the output vector is defined by a vector (y₁, y₂) of the size range of the lost circulation channel; m denotes a number of training samples of the prediction model for the size range of the lost circulation channel; n denotes a total number of features in the prediction dataset of the size range of the lost circulation channel; y₁ denotes a minimum value of the size range of the lost circulation channel; and y₂ denotes a maximum value of the size range of the lost circulation channel.

In step S43, the input vector Z^{[i]} and the output vector A^{[i]} of each layer of the prediction model for the size range of the lost circulation channel are calculated as follows:

Z^{[i]}=W^{[i]}X^{{i}}+b^{[i]}

A^{[i]}=g^{[i]}(Z^{[i]})

where, W^{[i]} denotes a weight matrix of each layer of the prediction model for the size range of the lost circulation channel; b^{[i]} denotes a bias of each layer of the prediction model for the size range of the lost circulation channel; and g^{[i]} denotes an activation function of each layer of the prediction model for the size range of the lost circulation channel.

In step S43, the prediction vector y of the prediction model for the size range of the lost circulation channel is calculated as follows:

ŷ⁽ⁱ⁾=g^{[L]}(Z^{[L]})

where, g^{[L]} denotes an activation function of a last layer of the prediction model for the size range of the lost circulation channel; and Z^{[L]} denotes an input vector of the last layer of the prediction model for the size range of the lost circulation channel.

In step S44, the loss cost function J of the prediction model for the size range of the lost circulation channel is calculated as follows:

$$J = \frac{1}{256} {\sum }_{i = 1}^{256} L ( {\hat{y}}^{( i )} , {y}^{( i )} ) + \frac{λ}{2 * 256} {\sum }_{256} {‖ {W}^{[ 256 ]} ‖}_{F}^{2}$$

where, ŷ⁽ⁱ⁾ denotes the prediction vector of the prediction model for the size range of

the lost circulation channel; y⁽ⁱ⁾ denotes the true vector of the size range of the lost circulation channel; L(ŷ⁽ⁱ⁾,y⁽ⁱ⁾) denotes a regularized loss function of the prediction model for the size range of the lost circulation channel; λ denotes a regularization parameter of the prediction model for the size range of the lost circulation channel; and ||W^{[256]}||_{F}² denotes a square of Frobenius norm of the weight matrix of the prediction model for the size range of the lost circulation channel.

In step S46, the exponentially weighted average v^{dw}* of the Momentum weighted differential, the exponentially weighted average v_{db}* of the Momentum biased differential, the weighted average S_{dW}* of the square of the RMSprop weighted differential, and the weighted average S_{db}* of the square of the RMSprop biased differential are calculated as follows:

v_{dW}*=β₁v_{dW}+(1−β₁)dW

v_{db}*=β₁v_{db}+(1−β₁)db

S_{dW}*=β₂S_{dW}+(1−β₂)(dW)²

S_{db}*=β₂S_{db}+(1−β₂)(db)²

where, V_{dW} denotes an exponentially weighted average of an original Momentum weighted differential; V_{db} denotes an exponentially weighted average of an original Momentum biased differential; S_{dW} denotes a weighted average of a square of an original RMSprop weighted differential; S_{db} denotes a weighted average of a square of an original RMSprop biased differential; β₁ denotes a first hyper-parameter of the prediction model for the size range of the lost circulation channel; and β₂ denotes a second hyper-parameter of the prediction model for the size range of the lost circulation channel. The first hyper-parameter and the second hyper-parameter are set to 0.9 and 0.999 respectively. v_{dW}, V_{db}, S_{dW}, and S_{db} are initialized as 0.

In step S46, the weighted average v_{dW}^{corrected} of the corrected Momentum weighted differential, the exponentially weighted average V_{db}^{corrected} of the corrected Momentum biased differential, the weighted average S_{dW}^{corrected} of the square of the corrected RMSprop weighted differential, and the weighted average S_{db}^{corrected} of the square of the corrected RMSprop biased differential are calculated as follows:

$${v}_{dW}^{corrected} = \frac{{v}_{dW}}{1 - {β}_{1}^{q}}$$

$${v}_{db}^{corrected} = \frac{{v}_{db}}{1 - {β}_{1}^{q}}$$

$${S}_{dW}^{corrected} = \frac{{S}_{dW}}{1 - {β}_{2}^{q}}$$

$${S}_{db}^{corrected} = \frac{{S}_{db}}{1 - {β}_{2}^{q}}$$

where, q denotes the current iteration number.

In step S47, an updated weight and bias of the prediction model for the size range of the lost circulation channel are calculated as follows:

$${W}^{*} = W - \frac{α {v}_{dW}^{corrected}}{\sqrt{{S}_{dW}^{corrected}} + ε}$$

$${b}^{*} = b - \frac{α {v}_{db}^{corrected}}{\sqrt{{S}_{db}^{corrected}} + ε}$$

where, W* denotes the updated weight of the prediction model for the size range of the lost circulation channel; b* denotes the updated bias of the prediction model for the size range of the lost circulation channel; W denotes the weight of the prediction model for the size range of the lost circulation channel; b denotes the bias of the prediction model for the size range of the lost circulation channel; a denotes a learning rate of the prediction model for the size range of the lost circulation channel; and ε denotes an infinitesimal, set to 10⁻⁸.

Those of ordinary skill in the art will understand that the embodiments described herein are intended to help readers understand the principles of the present disclosure, and it should be understood that the protection scope of the present disclosure is not limited to such special statements and embodiments. Those of ordinary skill in the art may make other various specific modifications and combinations according to the technical teachings disclosed in the present disclosure without departing from the essence of the present disclosure, and such modifications and combinations still fall within the protection scope of the present disclosure.

What is claimed is:

1. A method for predicting a size range of a lost circulation channel based on deep learning (DL), comprising the following steps:
S1: acquiring data of the lost circulation channel, and establishing a prediction dataset of the size range of the lost circulation channel;
S2: preprocessing the prediction dataset of the size range of the lost circulation channel, and determining the size range of the lost circulation channel;
S3: establishing a prediction model for the size range of the lost circulation channel by taking the pre-processed prediction dataset of the size range of the lost circulation channel as an input and the size range of the lost circulation channel as an output;
S4: optimizing the prediction model for the size range of the lost circulation channel, and predicting the size range of the lost circulation channel through the optimized prediction model for the size range of the lost circulation channel;
wherein in step S2, the preprocessing the prediction dataset of the size range of the lost circulation channel comprises: performing data cleaning, feature coding, and data normalization in sequence on the prediction dataset of the size range of the lost circulation channel to obtain a feature vector, thus completing data preprocessing;
in step S2, the data normalization is calculated as follows:
$${x}_{i} = \frac{{x}_{raw} - {x}_{min}}{{x}_{max} - {x}_{min}}$$
wherein, xᵢ∈{x₁,x₁ . . . , xₙ}; n denotes a total number of features in the prediction dataset of the size range of the lost circulation channel; x i denotes normalized feature data of the size range of the lost circulation channel; x_{raw} denotes raw feature data; xₘᵢₙ denotes minimum feature data; and xₘₐₓ denotes maximum feature data;
in step S2, the size range of the lost circulation channel is calculated as follows:
D₅₀=(0.2−0.5)W_{f}
D₅₀=(0.2−0.5)W_{f}
y₁=1/2(2D₅₀+10/7D₉₀)
y₂=1/2(5D₅₀+2D₉₀)
wherein, (y₁, y₂) denotes a vector of the size range of the lost circulation channel; y₁ denotes a minimum value of the size range of the lost circulation channel; y₂ denotes a maximum value of the size range of the lost circulation channel; D₅₀ denotes a particle size corresponding to a cumulative particle size distribution 50% of a lost circulation control formula; D₉₀ denotes a particle size corresponding to a cumulative particle size distribution 90% of the lost circulation control formula; and W_{f} denotes a size of the lost circulation channel;
step S4 comprises the following sub-steps:
S41: establishing a training sample matrix of the prediction model for the size range of the lost circulation channel;
S42: dividing the training sample matrix into subsets, and setting a number of iterations;
S43: calculating an input vector and an output vector of each layer of the prediction model for the size range of the lost circulation channel in each of the subsets, until a prediction vector of the prediction model for the size range of the lost circulation channel is obtained;
S44: calculating a loss cost function of the prediction model for the size range of the lost circulation channel in each of the subsets according to the prediction vector of the prediction model for the size range of the lost circulation channel;
S45: calculating a weighted differential and a biased differential of each layer of the prediction model for the size range of the lost circulation channel through a back-propagation (BP) algorithm;
S46: calculating an exponentially weighted average of a Momentum weighted differential, an exponentially weighted average of a Momentum biased differential, a weighted average of a square of an RMSprop weighted differential, and a weighted average of a square of an RMSprop biased differential; and calculating an exponentially weighted average of a corrected Momentum weighted differential, an exponentially weighted average of a corrected Momentum biased differential, a weighted average of a square of a corrected RMSprop weighted differential, and a weighted average of a square of a corrected RMSprop biased differential, according to the exponentially weighted average of the Momentum weighted differential, the exponentially weighted average of the Momentum biased differential, the weighted average of the square of the RMSprop weighted differential, and the weighted average of the square of the RMSprop biased differential;
S47: updating a weight and a bias of the prediction model for the size range of the lost circulation channel; and
S48: repeating steps S43 to S47 until the set number of iterations to complete the optimization of the prediction model for the size range of the lost circulation channel, and predicting the size range of the lost circulation channel through the optimized prediction model for the size range of the lost circulation channel;
wherein in step S41, the training sample matrix comprises an input matrix X defined by a feature vector and an output matrix Y defined a vector of the size range of the lost circulation channel, wherein X=[x⁽¹⁾|x⁽²⁾|x⁽³⁾ . . . x^{(m)}], Y=[y⁽¹⁾|y⁽²⁾]; x⁽¹⁾ . . . x^{(m)} denotes an input parameter vector of the prediction model for the size range of the lost circulation channel, and each term of the input parameter vector is defined by the feature vector (x₁, x₁ . . . , xₙ); y⁽¹⁾ and y⁽²⁾ denote an output vector of the prediction model for the size range of the lost circulation channel, and each term of the output vector is defined by a vector (y₁, Y₂) of the size range of the lost circulation channel; m denotes a number of training samples of the prediction model for the size range of the lost circulation channel; n denotes a total number of features in the prediction dataset of the size range of the lost circulation channel; y₁ denotes a minimum value of the size range of the lost circulation channel; and y₂ denotes a maximum value of the size range of the lost circulation channel;
in step S43, the input vector Z^{[i]} and the output vector A^{[i]} of each layer of the prediction model for the size range of the lost circulation channel are calculated as follows:
Z^{[i]}=W^{[i]}X^{[i]}+b^{[i]}
A^{[i]}=g^{[i]}(Z^{[i]})
wherein, W^{[i]} denotes a weight matrix of each layer of the prediction model for the size range of the lost circulation channel; b^{[i]} denotes a bias of each layer of the prediction model for the size range of the lost circulation channel; and g^{[i]} denotes an activation function of each layer of the prediction model for the size range of the lost circulation channel;
in step S43, the prediction vector ŷ⁽ⁱ⁾ of the prediction model for the size range of the lost circulation channel is calculated as follows:
ŷ⁽ⁱ⁾=g^{[L]}(Z^{[L]})
wherein g^{[L]} denotes an activation function of a last layer of the prediction model for the size range of the lost circulation channel; and Z^{[L]} denotes an input vector of the last layer of the prediction model for the size range of the lost circulation channel;
in step S44, the loss cost function J of the prediction model for the size range of the lost circulation channel is calculated as follows:
J=1/256Σᵢ₌₁²⁵⁶ L(ŷ⁽ⁱ⁾,y⁽ⁱ⁾)+λ/2*256Σ₂₅₆ ∥W^{[256]}∥_{F}²
wherein, ŷ⁽ⁱ⁾ denotes the prediction vector of the prediction model for the size range of the lost circulation channel; λ denotes a true vector of the size range of the lost circulation channel; L(ŷ⁽ⁱ⁾,y⁽ⁱ⁾) denotes a regularized loss function of the prediction model for the size range of the lost circulation channel; λ denotes a regularization parameter of the prediction model for the size range of the lost circulation channel; and ∥W^{[256]}∥_{F}² denotes a square of Frobenius norm of the weight matrix of the prediction model for the size range of the lost circulation channel;
in step S46, the exponentially weighted average v_{dw}* of the Momentum weighted differential, the exponentially weighted average v_{db}* of the Momentum biased differential, the weighted average S_{dw}* of the square of the RMSprop weighted differential, and the weighted average S_{db}* of the square of the RMSprop biased differential are calculated as follows:
v_{dW}*=β₁v_{dW}+(1−β₁)dW
v_{db}*=β₁v_{db}+(1−β₁)db
S_{dW}*=β₂S_{dW}+(1−β₂)(dW)²
S_{db}*=β₂S_{db}+(1−β₂)(db)²
wherein, dw denotes a differential of the weight matrix of the prediction model for the size range of the lost circulation channel; db denotes a differential of the bias of the prediction model for the size range of the lost circulation channel; v_{dw} denotes an exponentially weighted average of an original Momentum weighted differential; v_{db} denotes an exponentially weighted average of an original Momentum biased differential; S_{dw} denotes a weighted average of a square of an original RMSprop weighted differential; S_{db} denotes a weighted average of a square of an original RMSprop biased differential; β₁ denotes a first hyper-parameter of the prediction model for the size range of the lost circulation channel; and β₂ denotes a second hyper-parameter of the prediction model for the size range of the lost circulation channel;
in step S46, the exponentially weighted average v_{dW}^{corrected} of the corrected Momentum weighted differential, the exponentially weighted average v_{db}^{corrected} of the corrected Momentum biased differential, the weighted average S_{dw}^{corrected} of the square of the corrected RMSprop weighted differential, and the weighted average S_{db}^{corrected} of the square of the corrected RMSprop biased differential are calculated as follows:
$${v}_{dW}^{corrected} = \frac{{v}_{dW}}{1 - {β}_{1}^{q}}$$
$${v}_{db}^{corrected} = \frac{{v}_{db}}{1 - {β}_{1}^{q}}$$
$${S}_{dW}^{corrected} = \frac{{S}_{dW}}{1 - {β}_{2}^{q}}$$
$${S}_{db}^{corrected} = \frac{{S}_{db}}{1 - {β}_{2}^{q}}$$
wherein, q denotes a current iteration number;
in step S47, an updated weight and bias of the prediction model for the size range of the lost circulation channel are calculated as follows:
$${W}^{*} = W - \frac{{av}_{dW}^{corrected}}{\sqrt{{S}_{dW}^{corrected}} + ε}$$
$${b}^{*} - b - \frac{{av}_{db}^{corrected}}{\sqrt{{S}_{db}^{corrected}} + ε}$$
wherein, W* denotes the updated weight of the prediction model for the size range of the lost circulation channel; b* denotes the updated bias of the prediction model for the size range of the lost circulation channel; W denotes the weight of the prediction model for the size range of the lost circulation channel; b denotes the bias of the prediction model for the size range of the lost circulation channel; a denotes a learning rate of the prediction model for the size range of the lost circulation channel; and ε denotes an infinitesimal.

2. The method for predicting the size range of the lost circulation channel based on DL according to claim 1, wherein in step S1, the prediction dataset of the size range of the lost circulation channel comprises a drilling parameter, a drilling fluid parameter, a geomechanical model parameter, and a lost circulation parameter; and
the drilling parameter comprises a well depth, a borehole size, a penetration rate, a rotary speed, a torque, a weight on bit, a displacement, a pump pressure, a pump stroke, and a well trajectory; the drilling fluid parameter comprises a density, a Marsh funnel viscosity, a plastic viscosity, a yield point, an initial gel strength, a final gel strength, a filtration, and a solid content; the geomechanical model parameter comprises a lithology type, a rock mechanical parameter, a pore pressure, a formation fracture pressure, a vertical stress, a minimum horizontal stress, and a maximum horizontal stress; the lost circulation parameter comprises a lost circulation speed, a lost circulation amount, a lost circulation time, a lost circulation degree, a lost circulation condition, and a bit position; and the rock mechanical parameter comprises an elastic parameter, an unconfined compressive strength, a tensile strength, a shear strength, an internal friction angle, and a cohesion strength.

3-4. (canceled)

5. The method for predicting the size range of the lost circulation channel based on DL according to claim 1, wherein in step S3, the establishing the prediction model for the size range of the lost circulation channel comprises: designing, by taking the pre-processed prediction dataset of the size range of the lost circulation channel as the input, a regularized loss function L(ŷ⁽ⁱ⁾,y⁽ⁱ⁾) and a performance evaluation index mean square error (MSE) of the prediction model for the size range of the lost circulation channel, and setting parameters of the prediction model for the size range of the lost circulation channel, namely a number L of hidden layers, a number n^{(L)} of neurons in each of the hidden layers, and an activation function g(x) corresponding to each of the hidden layers; and iterating, according to the regularized loss function L(ŷ⁽ⁱ⁾,y⁽ⁱ⁾) of the prediction model for the size range of the lost circulation channel, a model with the number L of the hidden layers, the number n^{(L)} of the neurons in each of the hidden layers, and the activation function g(x) corresponding to each of the hidden layers, until an optimal performance evaluation index MSE, thus completing the establishment of the prediction model for the size range of the lost circulation channel, wherein, ŷ⁽ⁱ⁾ denotes a prediction vector of the prediction model for the size range of the lost circulation channel; and y⁽ⁱ⁾ denotes a true vector of the size range of the lost circulation channel.

6. The method for predicting the size range of the lost circulation channel based on DL according to claim 5, wherein an output layer of the prediction model for the size range of the lost circulation channel takes a rectified linear unit (ReLU) function as an activation function;
the regularized loss function L(ŷ⁽ⁱ⁾,y⁽ⁱ⁾) of the prediction model for the size range of the lost circulation channel is expressed as follows:
$$L ( {\hat{y}}^{( i )} , {y}^{( i )} ) = \frac{1}{2 m} {\sum }_{i = 1}^{m} [ {( ( {\hat{y}}^{( i )} ) - {y}^{( i )} )}^{2} + λ {‖ W ‖}^{2} ) ]$$
wherein, ŷ⁽ⁱ⁾ denotes the prediction vector of the prediction model for the size range of the lost circulation channel; y⁽ⁱ⁾ denotes the true vector of the size range of the lost circulation channel; m denotes a number of samples in the dataset; λ denotes a regularization parameter of the prediction model for the size range of the lost circulation channel; and W denotes a weight matrix of the prediction model for the size range of the lost circulation channel; ∥W∥² denotes an Euclidean norm of the weight matrix; and
the performance evaluation index MSE of the prediction model for the size range of the lost circulation channel is calculated as follows:
$$MSE = \frac{1}{m} {\sum }_{i = 1}^{m} {( {y}^{( i )} - {\hat{y}}^{( i )} )}^{2} .$$

7-8. (canceled)
